(19) United States
(12) Patent Application Publication
(10) Pub. No.: US 2012/0140305 A1
(43) Pub. Date: Jun. 7, 2012

(54) REFLECTION TYPE DISPLAY DEVICE

(75) Inventors: Yuhji Yashiro, Osaka-shi (JP); Hiroaki Shigeta, Osaka-shi (JP)

(73) Assignee: SHARP KABUSHIKI KAISHA, Osaka-shi, Osaka (JP)

(21) Appl. No.: 13/390,477

(22) PCT Filed: Mar. 18, 2010
(86) PCT No.: PCT/JP2010/001939

§ 371 Date: Feb. 14, 2012

(30) Foreign Application Priority Data
Aug. 28, 2009 (JP) 2009-198450

(51) Int. Cl. G02F 1/01; G02B 26/02; B82Y 20/00

(52) U.S. Cl. 359/230; 359/241; 977/773; 977/952; 977/810; 977/785

(57) ABSTRACT

A reflection type display device (10) includes: a plasmon resonance layer (32) in which metal nanoparticles (80) are dispersed; a band-pass filter (40); a light shutter (20); and a silicon solar cell layer (50a) being provided close to the plasmon resonance layer (32). The band-pass filter (40) and the light shutter (20) are provided so as to overlap the plasmon resonance layer (32) in planar view. The reflection type display device (10) performs display in such a manner that: the metal nanoparticles (80) allow light having a specific wavelength to pass through; the light is then reflected by the band-pass filter (40); and the light shutter (20) adjusts an intensity of the light thus reflected.

### REFERENCE TO RELATED APPLICATIONS

This application is the national stage under 35 USC 371 of International Application No. PCT/JP2010/001939, filed Mar. 18, 2010, which claims priority from Japanese Patent Application No. 2009-198450, filed Aug. 28, 2009, the entire contents of which are incorporated herein by reference.

### FIELD OF THE INVENTION

The present invention relates to a reflection type display device which achieves a high light utilization efficiency. Specifically, the present invention relates to a reflection type display device which makes it possible to reuse, by use of a solar cell, light unnecessary for display.

### BACKGROUND OF THE INVENTION

Conventionally proposed as reflection type display devices capable of color display are, e.g., a color electronic paper and a reflection type display device of an IMOD (Interferometric Modulator) type utilizing reflection interference.

FIG. 10 is a cross-sectional view illustrating a schematic arrangement of the color electronic paper. FIG. 11 is a cross-sectional view illustrating a schematic arrangement of the reflection type display device of the IMOD type.

As illustrated in FIG. 10, a color electronic paper 110 is arranged such that a cholesteric liquid crystal layer 112 for blue, a cholesteric liquid crystal layer 114 for green, a cholesteric liquid crystal layer 116 for red, and a light absorbing layer 118 are stacked in this order.

Further, as illustrated in FIG. 11, a reflection type display device 120 of the IMOD type has, on a glass substrate 122, metal layers 126 which sandwich a silicon dioxide 124 and which serve as absorbing layers, and a reflecting metal layer 128 which is provided on the metal layer 126 via a gap 130.

The color electronic paper 110 performs color display in such a manner that the cholesteric liquid crystal layer 112 for blue, the cholesteric liquid crystal layer 114 for green, and the cholesteric liquid crystal layer 116 for red generate blue reflected light, green reflected light, and red reflected light, respectively. The color electronic paper 110 also performs black display in such a manner that the light absorbing layer 118 absorbs light.

The reflection type display device 120 of the IMOD type performs color display by, e.g., adjusting a dimension of the gap 130 so as to adjust a color of reflected light by reflection interference.

Thus, each of the color electronic paper 110 and the reflection type display device 120 performs display by reflecting light having a specific wavelength and absorbing the remaining light having an unnecessary wavelength.

In another example, a reflection type display device performs color display in such a manner that, e.g., its color filter absorbs light having an unnecessary wavelength.

As described above, these conventional reflection type display devices which perform color display absorb light unnecessary for display (unnecessary light) by use of the absorbing layer or the color filter so that the light is not utilized. Accordingly, an energy corresponding to the unnecessary light is wasted.

In view of this, demanded is a technique for increasing light utilization efficiency. For example, the following techniques have n proposed.

(Patent Literature 1)

Patent Literature 1 proposes a display device having a solar cell. Specifically, the display device is arranged such that: a transparent dye-sensitized solar cell is provided on a surface of the display device; an anode electrode of the solar cell is provided on an incoming light side; and an cathode electrode of the solar cell is provided on a display device side.

According to Patent Literature 1, the display device having a solar cell makes it possible to provide a display device which can secure photocarrier generation efficiency and visibility.

(Patent Literature 2)

Patent Literature 2 proposes that display element capable of color display which utilizes color development by metal fine particles.

Specifically, Patent Literature 2 proposes a display element which is arranged such that the metal fine particles and a matrix structure are provided on at least one of a pair of substrates.

According to Patent Literature 2, the display element makes it possible to provide that display element having a good visibility which utilizes absorption and transmission of natural light by the metal fine particles.

### CITATION LIST

Patent Literature 1
Japanese Patent Application Publication, Tokukai, No. 2002-229472 A (Publication Date: Aug. 14, 2002)
Japanese Patent Application Publication, Tokukai, No. 2005-284215 A (Publication Date: Oct. 13, 2005)

### SUMMARY OF INVENTION

However, the conventional techniques has the following problems.

That is, the display device disclosed in Patent Literature 1 has a risk of deterioration of its display performance. This is because the solar cell provided in the display device is arranged to absorb light emitted from the display device itself.

Further, the display element disclosed in Patent Literature 2 has a problem in that its light utilization efficiency is not high. This is because Patent Literature 2 does not consider, e.g., utilizing evanescent light for color development which is caused by plasmon oscillations (resonance) of metal fine particles.

That is, in the display element of Patent Literature 2, light is absorbed by plasmon resonance so that energy corresponding to the light is lost. Therefore, the display element of Patent Literature 2 has a problem in that energy of incoming light cannot be fully utilized.

In view of this, the present invention was made to solve the problems. An object of the present invention is to provide a reflection type display device which achieves a high light utilization efficiency and high-definition display.

In order to attain the object, a reflection type display device of the present invention includes: a metal nanoparticle dispersion layer in which metal nanoparticles are dispersed; a reflector being provided so as to overlap said metal nanoparticle dispersion layer in planar view; a light shutter being provided so as to overlap said metal nanoparticle dispersion layer in planar view; and a solar cell layer being provided close to said metal nanoparticle dispersion layer, the reflection type display device performing display in such a manner that: the metal nanoparticles allow light having a specific wavelength to pass through; the light is then reflected by said reflector; and said light shutter adjusts an intensity of the light thus reflected.

According to the arrangement, the metal nanoparticles allow the light having a specific wavelength to pass through. That is, colors are developed by the metal nanoparticles.

This is attributed to plasmon resonance which occurs on the surfaces of the metal nanoparticles. That is, the metal nanoparticles absorb light in such a manner that an optical electric field in a visible light region etc. and a plasmon are coupled to each other. Light which is not absorbed passes through the metal nanoparticles. Accordingly, the metal nanoparticles develop vivid colors due to the plasmon resonance. The “plasmon” indicates that free electrons in a metal collectively oscillate so as to behave as quasiparticles.

According to the arrangement, after passing through the metal nanoparticles, the light having a specific wavelength is reflected by the reflector, and an intensity of the reflected light is adjusted by the light shutter. This allows high-definition display.

Further, according to the arrangement, the solar cell layer is provided close to the metal nanoparticle dispersion layer.

This makes it possible to absorb, by use of the solar cell layer, the evanescent wave from the metal nanoparticles. This makes it possible to increase a light utilization efficiency.

That is, as a result of light absorption due to plasmon resonance, an evanescent wave, which does not propagate, is caused in the vicinity of the surfaces of the metal nanoparticles. Herein, the evanescent wave refers to light which leaks out from an interface between materials with different refractive indexes in a case where light is totally reflected on the interface.

The evanescent wave which has leaked from the metal nanoparticles further leaks out to the solar cell layer provided close to the metal nanoparticle dispersion layer. Thus, the evanescent wave is stored in the metal nanoparticle dispersion layer as energy.

The energy can be used in display of the display device such as driving of the light shutter. Thus, the light absorbed by the metal nanoparticles can be utilized as energy. This increases a light utilization efficiency.

Thus, the reflection type display device achieves a high light utilization efficiency and high-definition display.

The specific wavelength of the light refers to a wavelength which depends on a material for the metal nanoparticles and a particle diameter thereof. For example, such wavelengths indicate red, green, and blue of the RGB (Red-Green-Blue) colors, and cyan (blue green), magenta (reddish purple), yellow of the CMY colors

### (Cyan-Magenta-Yellow).

The arrangement recited as “a solar cell layer being provided close to said metal nanoparticle dispersion layer” indicates not only that the solar cell layer has a direct contact with the metal nanoparticle dispersion layer but also that the solar cell layer is provided so as to have an indirect contact via an insulator layer such as the oxidized film layer. That is, indicated is that the solar cell layer is provided in a position where the solar cell layer can absorb the evanescent wave from the metal nanoparticle in the metal nanoparticle dispersion layer.

As described above, the reflection type display device of the present invention is arranged such that said solar cell layer is provided close to said metal nanoparticle dispersion layer, and the reflection type display device performs display in such a manner that: the metal nanoparticles allow light having a specific wavelength to pass through; the light is then reflected by said reflector; and said light shutter adjusts an intensity of the light thus reflected.

This makes it possible to provide a reflection type display device which can achieve a high light utilization efficiency and a high-definition display.

### BRIEF DESCRIPTION OF DRAWINGS

FIG. 1 is a view illustrating a schematic arrangement of a reflection type display device of an embodiment of the present invention.

FIG. 2 is a view illustrating the embodiment of the present invention, which view mainly illustrates a schematic arrangement of a main part.

FIG. 3 is a view showing relationships between wavelengths and absorbances of metal nanoparticles of the embodiment of the present invention. (a) of FIG. 3 is a graph for the gold particles having a particle diameter of 10 nm. (b) of FIG. 3 is a graph for the gold particles having a particle diameter of 40 nm. (c) of FIG. 3 is a graph for the copper particles having a particle diameter of 10 nm.

FIG. 4 is a view illustrating Embodiment 3 of the present invention, which view mainly illustrates a schematic arrangement of a main part.

FIG. 5 is a view showing relationships between wavelengths and absorbances of metal nanoparticles of Embodiment 3 of the present invention. (a) of FIG. 5 is a graph for the gold particles having a particle diameter of 10 nm. (b) of FIG. 5 is a graph for mixed particles of the gold particles having a particle diameter of 40 nm and copper particles having a particle diameter of 10 nm. (c) of FIG. 5 is a graph for the copper particles having a particle diameter of 10 nm.

FIG. 6 is a view illustrating a schematic arrangement of a reflection type display device of Embodiment 4 of the present invention.

FIG. 7 is a view illustrating Embodiment 4 of the present invention, which view mainly illustrates a schematic arrangement of a main part.

FIG. 8 is a view illustrating Embodiment 5 of the present invention, which view mainly illustrates a schematic arrangement of a main part.

FIG. 9 is a view illustrating a schematic arrangement of a reflection type display device of Embodiment 6 of the present invention.

FIG. 10 is a cross-sectional view illustrating a schematic arrangement of a color electronic paper according to a conventional technique.

FIG. 11 is a cross-sectional view illustrating a schematic arrangement of an IMOD-type reflection type display device according to a conventional technique.

### DETAILED DESCRIPTION OF THE INVENTION

The following describes embodiments of the present invention in detail.

### Embodiment 1

The following describes an embodiment of the present invention, with reference to FIGS. 1 through 3.

(Schematic Arrangement)

As illustrated in FIG. 1, a reflection type display device 10 of the present embodiment includes a light shutter 20, a main part 30, a band-pass filter 40 which serves as a reflector, and a storage battery 90. The main part 30 is constituted mainly by a plasmon resonance layer 32 which serves as a metal nanoparticle dispersion layer in which metal nanoparticles 80 are dispersed (including being deposited, being arrayed, etc.), and a solar cell layer 50 provided close to the plasmon resonance layer 32.

The light shutter 20, the main part 30, and band-pass filter 40 are provided so as to overlap in planar view. The storage battery 90 is electrically connected with the main part 30, more specifically, connected with the solar cell layer 50 in the main part 30. The following describes these members.

(Main Part)

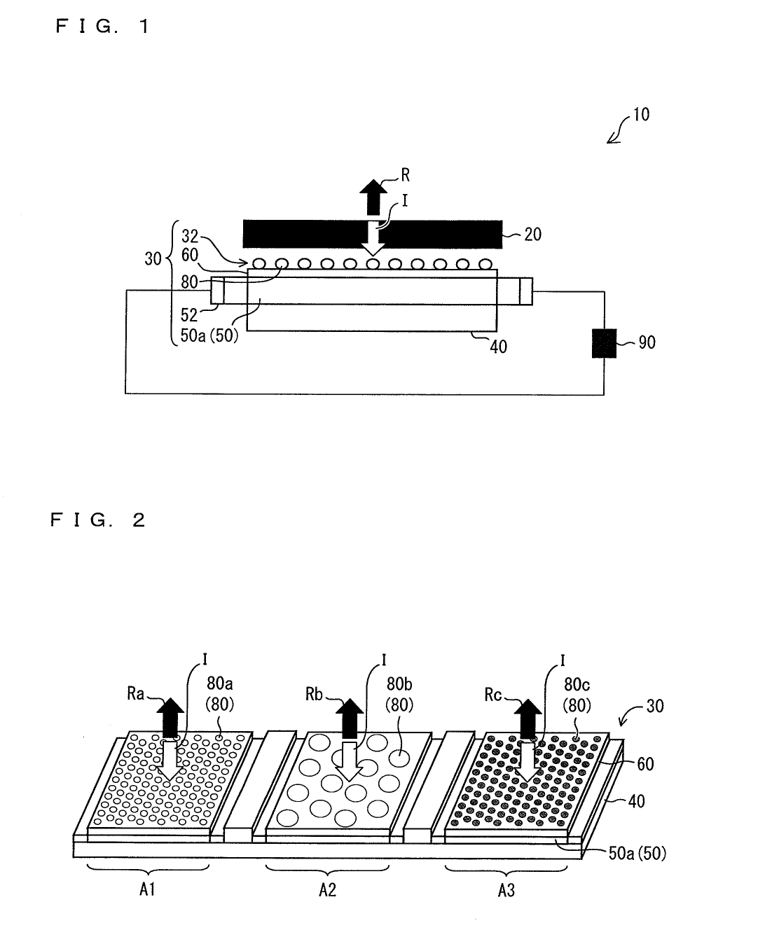

The following first describes the main part 30, with reference to FIGS. 1 and 2. FIG. 2 is a view mainly illustrating a schematic arrangement of the main part 30 of the present embodiment.

As illustrated in FIGS. 1 and 2, the main part 30 is structured such that a silicon solar cell layer 50a which serves as a solar cell layer 50, and an oxidized film layer 60 which is ultrathin and serves as an insulator layer are stacked in this order. The metal nanoparticles 80 are deposited on a surface of the oxidized film layer 60 so that the plasmon resonance layer 32 is formed on the oxidized film layer 60. The deposition of the metal nanoparticles 80 is one example of dispersion of the metal nanoparticles 80. Hereinafter, the present embodiment takes the deposition of the metal nanoparticles 80 as an example.

As illustrated in FIG. 2, the main part 30 is divided into three display regions (subpixels).

As illustrated in FIG. 1, the reflection type display device 10 emits reflected light R having a specific wavelength, with respect to incoming light I having all wavelengths. For color display, the reflected light R having a specific wavelength contains reflected light R of three colors: red reflected light Ra, green reflected light Rb, and blue reflected light Rc.

The display regions of the reflection type display device 10 correspond to the colors of the reflected light R, respectively. That is, reflected light R of one color is emitted from a corresponding one of the display regions.

Specifically, the three display regions are: a red display region A1 which emits the red reflected light Ra; a green display region A2 which emits the green reflected light Rb; and a blue display region A3 which emits the blue reflected light Rc.

The three display regions are arranged in a matrix pattern.

The metal nanoparticles 80 differ in type among the three display regions in accordance with the three colors of the reflected light R. That is, deposited in the red display region A1 are metal nanoparticles capable of emitting red light; deposited in the green display region A2 are metal nanoparticles capable of emitting green light; and deposited in the blue display region A3 are metal nanoparticles capable of emitting blue light.

Specifically, deposited in the red display region A1 are metal nanoparticles of gold having a particle diameter of 10 nm (red metal nanoparticles 80a); deposited in the green display region A2 are metal nanoparticles of gold having a particle diameter of 40 nm (green metal nanoparticles 80b); and deposited in the blue display region A3 are metal nanoparticles of copper having a particle diameter of 10 nm (blue metal nanoparticles 80c).

(Manufacturing Method Etc.)

The following describes, in more detail, the main part 30 and the band-pass filter 40 of the present embodiment, including the manufacturing methods thereof.

(Band-Pass Filter)

The following first describes the band-pass filter 40. As described above, the band-pass filter 40 which serves as a reflector is provided so as to overlap the main part 30 in planar view.

The band-pass filter 40 is a filter for allowing light having a specific wavelength or a specific wavelength band to pass through so as to reflect its light portion on a short-wavelength side and its light portion on a long-wavelength side.

The band-pass filter 40 is formed by alternately stacking dielectric materials having respective different refractive indexes. Specifically, the band-pass filter 40 is a laminated film made up of silicon dioxide films and titanium dioxide films.

An arrangement of the band-pass filter 40 is not limited to the arrangement above. Suitably employed as the band-pass filter 40 is a laminate in which a low refractive index dielectric material and a high refractive index dielectric material are alternately stacked is suitably employed as the band-pass filter 40. For example, magnesium fluoride (MgF₂) may be employed as the low refractive index dielectric material, and tantalum oxide (Ta₂O₃) may be employed as the high refractive index dielectric material.

As the band-pass filter 40 which serves as a reflector, it is also possible to employ a film formed by polymer lamination and having high reflectances over a whole visible light region. Examples of such a film encompass an ESR (Enhanced Specular Reflector) film (name of a product of 3M).

A thickness of the band-pass filter 40 is preferably set to one which allows light in an intended wavelength band to satisfy the Bragg's condition of reflection.

The reflector is not limited to one realized as a band-pass filter. For example, the reflector may be one formed from a metal such as aluminum.

(Solar Cell Layer)

The following describes the solar cell layer 50 which is formed on the band-pass filter 40.

Although an arrangement of the solar cell layer 50 is not particularly limited, the solar cell layer 50 of the present embodiment is provided as the silicon solar cell layer 50a, as described above.

Specifically, a thin film having a thickness of 30 nm is formed from amorphous silicon, on the band-pass filter 40 which is a band-pass filter having a reflecting property in the visible light region, and then a p/i/n structure is formed on a flat surface of the thin film. The silicon solar cell layer 50a is thus made.

Further, a terminal 52 is provided to each of both ends of the silicon solar cell layer 50a, and the storage battery 90 is connected with the silicon solar cell layer 50a via the terminals 52.

A material for the solar cell layer 50 is not limited to amorphous silicon. Examples of other materials encompass CIS-based (chalcopyrite-based) materials to be described in Embodiment 5, and a microcrystalline silicon material having a particle diameter from e.g. approximately several dozens to 1000 angstroms.

(Metal Nanoparticles)

The following describes the metal nanoparticles 80.

First, the oxidized film layer 60 which is ultrathin is formed as an insulator layer, on the thin film of amorphous silicon. The oxidized film layer 60 has a thickness of 5 nm.

Then, the metal nanoparticles 80 are deposited on the oxidized film layer 60 so that the plasmon resonance layer 32 is formed. For example, the following method can be employed for the deposition of the metal nanoparticles 80 although a method for the deposition is not particularly limited.

That is, first, an ethanol solution in which the metal nanoparticles 80 are dispersed which have a uniform particle size is applied onto the oxidized film layer 60, and then the ethanol is evaporated. Thus, the metal nanoparticles 80 can be deposited on the oxidized film layer 60.

The following describes the metal nanoparticles 80 which are employed in the present embodiment.

The metal nanoparticles 80 vary in their reflection wavelength, depending on their material and their particle diameter. That is, a color of the reflected light R varies depending on their material and their particle diameter.

As described above, the main part 30 of the present embodiment is divided into three display regions, in accordance with the three colors of the reflected light R.

In the three display regions, specifically, in the red display region A1, gold particles having a particle diameter of 10 nm are deposited as the red metal nanoparticle 80a; in the green display region A2, gold particles having a particle diameter of 40 nm are deposited as the green metal nanoparticle 80b; and in the blue display region A3, copper particles having a particle diameter of 10 nm are deposited as the blue metal nanoparticle 80c.

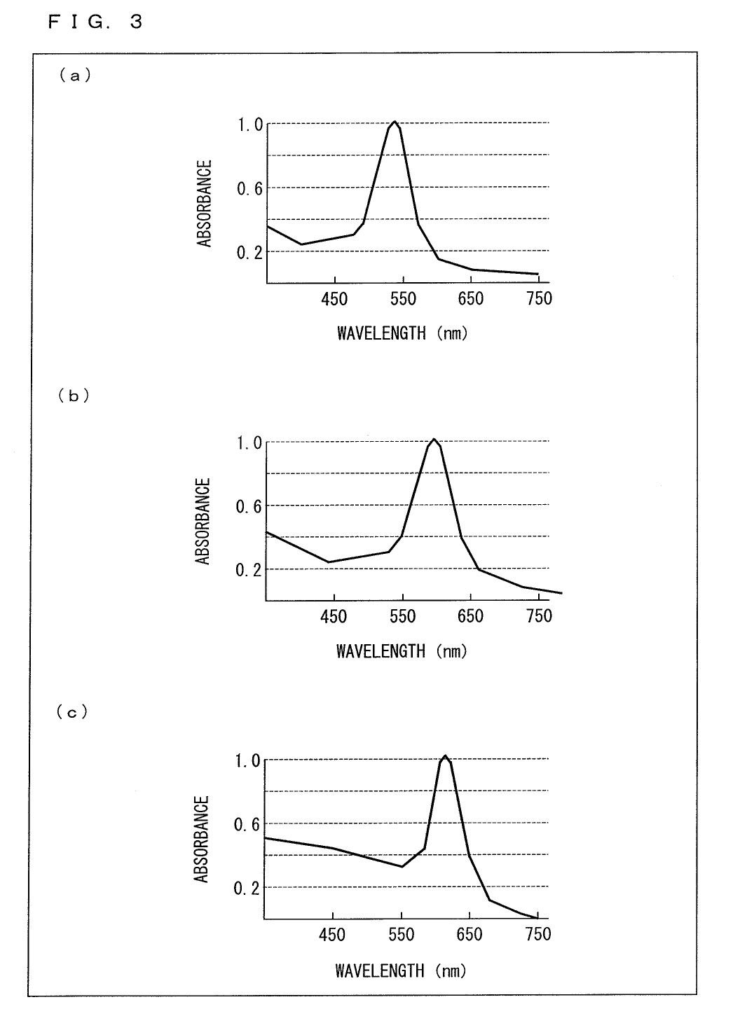

With reference to (a) through (c) of FIG. 3, the following describes light absorption characteristics of the metal nanoparticles 80. (a) through (c) of FIG. 3 are graphs each of which shows relationships between wavelengths and absorbances of the metal nanoparticles 80. (a) of FIG. 3 is a graph for the gold particles having a particle diameter of 10 nm. (b) of FIG. 3 is a graph for the gold particles having a particle diameter of 40 nm. (c) of FIG. 3 is a graph for the copper particles having a particle diameter of 10 nm.

As shown in (a) through (c) of FIG. 3, those gold particles having a particle diameter of 10 nm which serve as the red metal nanoparticles 80a correspond to red; those gold particles having a particle diameter of 40 nm which serve as the green metal nanoparticles 80b correspond to green; and those copper particles having a particle diameter of 10 nm which serve as the blue metal nanoparticles 80c correspond to blue. Specifically, the red metal nanoparticles 80a, the green metal nanoparticles 80b, and the blue metal nanoparticles 80c are different in wavelength of light which is absorbed by plasmon resonance to be described later. Accordingly, when light from a white light source enters the metal nanoparticles 80, transmitted light which has passed through the red metal nanoparticles 80a becomes red transmitted light; transmitted light which has passed through the green metal nanoparticles 80b becomes green transmitted light; and transmitted light which has passed through the blue metal nanoparticles 80c becomes blue transmitted light. As a result, after being reflected on the band-pass filter 40 which serves as a reflector, the red transmitted light, the green transmitted light, and the blue transmitted light are emitted from the reflection type display device 10 as the red reflected light Ra, the green reflected light Rb, and the blue reflected light Rc.

Thus, the reflection type display device 10 performs color display by color expression utilizing the three colors RGB (Red-Green-Blue).

It is possible to change the three colors by changing the materials and the particle diameters of the metal nanoparticles 80. Therefore, colors can also be expressed by use of, e.g., the three colors CMY (Cyan-Magenta-Yellow).

Although particle diameters of the metal nanoparticles 80 are not particularly limited, preferable particle diameters are, e.g., not smaller than 1 nm but not greater than 200 nm.

Although the materials for the metal nanoparticles 80 are not particularly limited, preferable materials are, e.g., silver, gold, copper, aluminum, and an alloy containing any of these metals.

(Plasmon Resonance)

The following describes how the reflection type display device 10 of the present embodiment performs display.

The reflection type display device 10 performs display by use of plasmon resonance of the metal nanoparticles 80.

That is, as shown in (a) and (b) of FIG. 3, the metal nanoparticles 80 absorb light in specific wavelength bands due to their plasmon resonance, so that the remaining light passes through the metal nanoparticles 80.

In the reflection type display device 10, the band-pass filter 40 which serves as a reflector is provided so as to overlap the main part 30 in planar view.

Accordingly, light which has externally entered the reflection type display device 10 (incoming light I) is partially absorbed by the metal nanoparticles 80, and then, the rest which is not absorbed (i.e., transmitted light) reaches the band-pass filter 40. Then, the transmitted light is reflected on the band-pass filter 40 so as to be emitted from the reflection type display device 10 as the reflected light R.

That is, the reflection type display device 10 performs display in such a manner that light having a wavelength which does not contribute to the plasmon resonance, i.e., the transmitted light is reflected by the reflector which is the band-pass filter 40 below the metal nanoparticles 80 in the main part 30 (in the cross-section of the main part 30, a plane which the incoming light I enters is defined as being on an upper side. In other words, that one side of the reflection type display device 10 which faces a main viewer is defined as the upper side).

Further, as described above, in the reflection type display device 10 of the present embodiment, the metal nanoparticles 80 (80a through 80c) corresponding to RGB are provided in corresponding display regions (A1 through A3). Therefore, the reflection type display device 10 can perform color display.

(Solar Cell Layer)

The reflection type display device 10 of the present embodiment can reuse light which has absorbed due to plasmon resonance. This makes it possible to increase light utilization efficiency.

That is, the light absorbed by the metal nanoparticles 80 due to their plasmon resonance exists as evanescent light in the vicinity of surfaces of the metal nanoparticles 80.

The reflection type display device 10 has the silicon solar cell layer 50a under the oxidized film layer 60 on which the metal nanoparticles 80 are deposited. This makes it possible to absorb the evanescent light by use of the silicon solar cell layer 50a.

That is, the evanescent light is absorbed by the amorphous silicon thin film of the silicon solar cell layer 50a via the oxidized film layer 60 provided between the metal nanoparticles 80 and the silicon solar cell layer 50a. Thus, the evanescent light is stored in the storage battery 90 so as to be reused.

(Light Shutter)

The following describes the light shutter 20.

As described with reference to FIG. 1, the reflection type display device 10 of the present embodiment has the light shutter 20 above the main part 30. That is, the light shutter 20 is provided between the metal nanoparticles 80 and a viewer of the reflection type display device 10.

The light shutter 20 adjusts an intensity of the reflected light R emitted from the main part 30, in accordance with an image to be displayed.

That, is the light shutter 20 is arranged to be an adjustable light shutter. Therefore, the light shutter 20 serves as a so-called light valve, specifically, performs gradation expression and black display by utilizing the reflected light R.

The light shutter 20 of the reflection type display device 10 of the present embodiment is not particularly limited. The light shutter 20 may be, e.g., a liquid crystal element (liquid crystal shutter element) or MEMS (Micro-Electro-Mechanical Systems).

The MEMS refers to a micro electric mechanical element, and is a generic term for very minute driving elements. Examples of light shutters made by a technique of MEMS encompass an element which opens and closes its minute shutter by an electrostatic force. Examples of such elements encompass a Digital Micro Shutter (DMS) of Pixtronix, Inc. in the U.S. which DMS laterally slides its light-blocking shutter for opening and closing thereof.

(Position of Light Shutter)

A position where the light shutter 20 is provided is not particularly limited. The light shutter 20 can be provided above or below the main part 30 of the reflection type display device 10 of the present invention.

In a case where the light shutter 20 is provided below the main part 30, there is a concern that Fresnel reflection etc. on an interface of the upper surface of the light shutter 20 brighten black display so that a contrast decreases. In a case where the light shutter 20 is provided above the main part 30, on the other hand, such a contrast decrease can be suppressed.

Embodiment 6 deals with an arrangement in which the light shutter 20 is provided in a different position.

The reflection type display device 10 of the present embodiment serves as a reflection type display device in such a manner that the light shutter 20 controls the reflected light R which is light reflected by the reflector after passing through the metal nanoparticles 80 (plasmon resonance layer 32).

Further, the reflection type display device 10 of the present embodiment can reuse as electric power, via the solar cell layer 50, light absorbed by the metal nanoparticles 80, i.e., the evanescent light. Accordingly, the reflection type display device 10 serves as a reflection type display device which achieves a high light utilization efficiency and low power consumption.

### Embodiment 2

The following describes another embodiment of the reflection type display device 10 of the present invention. The following explanation mainly deals with differences between the reflection type display device 10 of Embodiment 1 and a reflection type display device 10 of the present embodiment, and omits descriptions of common points therebetween.

The reflection type display device 10 of the present embodiment is different from the reflection type display device 10 of Embodiment 1, with regard to how to deposit (disperse) the metal nanoparticles 80 on the oxidized film layer 60.

That is, according to the Embodiment 1, an ethanol solution in which the metal nanoparticles 80 are dispersed is applied onto the oxidized film layer 60, and then the ethanol is evaporated so that the metal nanoparticles 80 are deposited on the oxidized film layer 60.

In the case of the reflection type display device 10 of the present embodiment, in contrast, the metal nanoparticles 80 are deposited by use of self-alignment of the silica nanoparticles so that the metal nanoparticles 80 are positioned in a regular manner. The following describes this specifically.

Before depositing the metal nanoparticles 80, first, a colloid solution in which silica nanoparticles having a uniform particle diameter are dispersed is applied onto the oxidized film layer 60 provided on the solar cell layer 50. Then, the solvent is evaporated so that the silica nanoparticles are deposited on the oxidized film layer 60. Employed in the present embodiment were silica nanoparticles having a particle diameter of 100 nm.

The silica nanoparticles have a property of depositing in a periodic-structured array in a self-organizing manner. Therefore, the silica nanoparticles thus deposited are used as a mask in vapor deposition of a metal material so that the metal nanoparticles 80 are formed (deposited).

After the vapor deposition of the metal material, the silica nanoparticles are removed so that only the metal nanoparticles 80 are left.

By selecting a particle diameter of the silica nanoparticles in accordance with a desired particle diameter of the metal nanoparticles 80, it is possible to deposit the metal nanoparticles 80 having the desired particle diameter.

(Method for Synthesizing Silica Nanoparticles)

The following describes one example of a method for synthesizing the silica nanoparticles.

Examples of a method for synthesizing the silica nanoparticles having a uniform particle diameter encompass such a method that hydrolysis and condensation polymerization of alkoxysilane (e.g., tetraethyl orthosilicate) which is a silica source are progressed in an ammonium/water/ethanol solution so that the silica nanoparticles are obtained. A particle diameter of the silica nanoparticles obtained by the method is approximately 100 nm.

In a case where an aqueous solution in which a basic amino acid such as lysine and arginine is dissolved is used as a solution in the method, obtained silica nanoparticles have a particle diameter of approximately 10 nm.

As described in Embodiment 1, the metal nanoparticles vary in their reflection wavelength, depending on their material and their particle diameter. In the method of the present embodiment for depositing metal nanoparticles, a particle diameter of the metal nanoparticles to be deposited varies depending on a particle diameter of the silica nanoparticles to be used.

In the present embodiment, by adjusting a particle diameter of the silica nanoparticles to be used, metal nanoparticles of gold having a particle diameter of 10 nm (red metal nanoparticles 80a) are deposited in a red display region A1; metal nanoparticles of gold having a particle diameter of 40 nm (green metal nanoparticles 80b) are deposited in a green display region A2; and metal nanoparticles of copper having a particle diameter of 10 nm (blue metal nanoparticles 80c) are deposited in a blue display region A3, as is the case with Embodiment 1.

The reflection type display device 10 of the present embodiment can perform color display of high light utilization efficiency and high definition, as is the case with the reflection type display device 10 of Embodiment 1.

### Embodiment 3

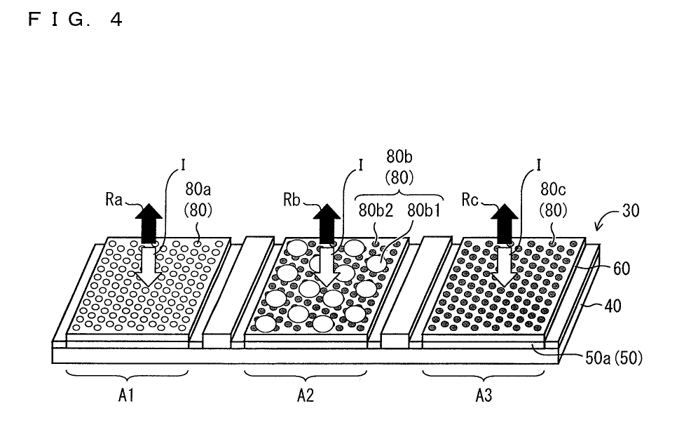

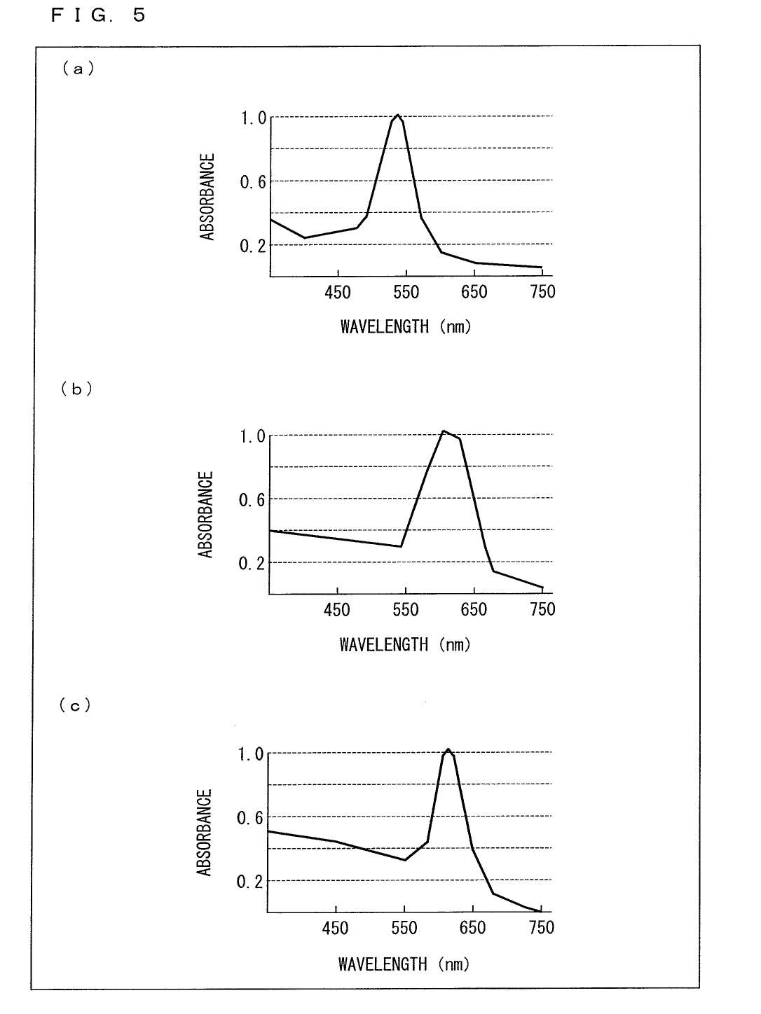

The following describes another embodiment of the reflection type display device 10 of the present invention, with reference to FIGS. 4 and 5.

For convenience of explanation, members having the same functions as those of the members in the drawings described in Embodiment 1 are given common reference signs, and descriptions of such members are omitted below.

Metal nanoparticles 80 to be deposited in a green display region A2 of the reflection type display device 10 of the present embodiment are different from those of the reflection type display device 10 of Embodiment 1.

That is, in the case of the reflection type display device 10 of Embodiment 1, one type of metal nanoparticles, i.e., the metal nanoparticles of gold having a particle diameter of 40 nm are deposited in the green display region A2 as the green metal nanoparticles 80b.

In contrast, in the case of the reflection type display device 10 of the present embodiment, two types of metal nanoparticles are deposited in the green display region A2. Specifically, the following two types of metal nanoparticles are deposited in the green display region A2 in the proportion of one to one: (i) metal nanoparticles of gold having a particle diameter of 40 nm (first green metal nanoparticle 80b1), and (ii) metal nanoparticles of copper having a particle diameter of 10 nm (second green metal nanoparticles 80b2).

FIG. 4 is a view mainly illustrating a schematic arrangement of a main part 30 of the present embodiment. As illustrated in FIG. 4, deposited in the green display region A2 of the present embodiment are the first green metal nanoparticles 80b1 (metal nanoparticles of gold having a particle diameter of 40 nm) and the second green metal nanoparticles 80b2 (metal nanoparticles of copper having a particle diameter of 10 nm).

(a) through (c) of FIG. 5 are graphs each of which shows relationships between wavelengths and absorbances of the metal nanoparticles 80. Specifically: (a) of FIG. 5 is a graph for the gold particles having a particle diameter of 10 nm; (b) of FIG. 5 is a graph for mixed particles of the gold particles having a particle diameter of 40 nm and copper particles having a particle diameter of 10 nm; and (c) of FIG. 5 is a graph for the copper particles having a particle diameter of 10 nm. (a) and (c) of FIG. 5 are the same as (a) and (c) of FIG. 3, respectively.

(b) of FIG. 5 shows that the mixture particles of the gold particles having a particle diameter of 40 nm and the copper particles having a particle diameter of 10 nm make it possible to obtain an absorption spectrum which is different from that absorption spectrum of the single type of gold particles having a particle diameter of 40 nm which is shown in (b) of FIG. 3. Specifically, the absorption spectrum of the mixed particles is flatter, in its change in absorbance with respect to wavelength, than that of the single type of particles.

Thus, the reflection type display device 10 of the present embodiment is arranged such that the metal nanoparticles 80 of not less than two types are deposited in one display region (subpixel). This makes it possible to fine adjust colors of the reflected light R. As a result, color purity can be increased.

### Embodiment 4

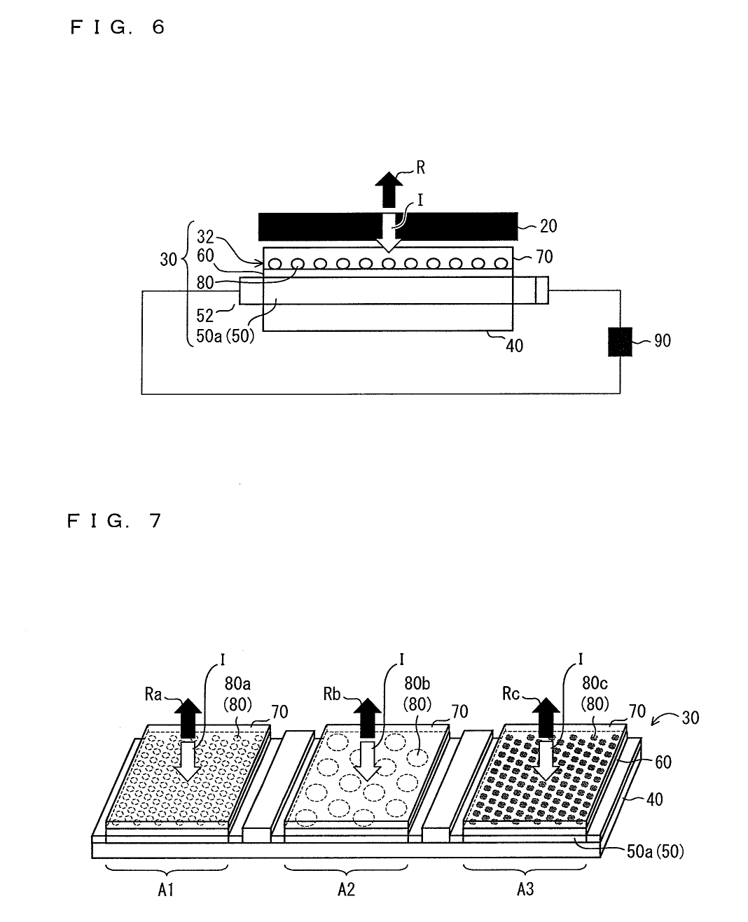

The following describes another embodiment of the reflection type display device 10 of the present invention, with reference to FIGS. 6 and 7.

For convenience of explanation, members having the same functions as those of the members in the drawings described in Embodiments 1 through 3 are given common reference signs, and descriptions of such members are omitted below.

The reflection type display device 10 of the present embodiment is different from the reflection type display device 10 of Embodiment 1, with regard to how to deposit (disperse) the metal nanoparticles 80 on the oxidized film layer 60.

That is, according to the Embodiment 1, an ethanol solution in which the metal nanoparticles 80 are dispersed is applied onto the oxidized film layer 60, and then the ethanol is evaporated so that the metal nanoparticles 80 are deposited on the oxidized film layer 60.

In the case of the reflection type display device 10 of the present embodiment, in contrast, a resin in which the metal nanoparticles 80 are dispersed is applied onto the oxidized film layer 60, and then, the resin is cured so that the metal nanoparticles 80 are deposited on the oxidized film layer 60.

FIG. 6 is a view illustrating a schematic arrangement of the reflection type display device 10 of the present embodiment. FIG. 7 is a view mainly illustrating a schematic arrangement of a main part 30 of the present embodiment.

As illustrated in FIGS. 6 and 7, in the main part 30 of the present embodiment, a UV (ultraviolet rays) curable resin layer 70 which serves as a dielectric layer is provided on the oxidized film layer 60.

The metal nanoparticles 80 are buried in the UV curable resin layer 70 entirely in Embodiments mentioned above, or at least partially. In other words, the metal nanoparticles 80 are encased in the dielectric layer.

Although the resin is not particularly limited, employed in the present embodiment is a UV curable resin which is cured by UV irradiation.

The UV curable resin is a cross-linked polymer which is produced in such a manner that by using, as initiating species, radicals and cations which are generated by light irradiation, polymerization of a monomer, an oligomer, or a polymer each of which has a polymerizing ability such as an epoxy group and a vinyl group.

The UV curable resin retains and also protects the metal nanoparticles 80.

A plasmon resonance wavelength is shifted depending on a dielectric constant of a dielectric material in the vicinity of the metal nanoparticles 80. Accordingly, by changing a dielectric constant of the UV curable resin which serves as a dielectric material, it is possible to adjust a plasmon resonance wavelength. In other words, by changing a refractive index of the UV curable resin, it is possible to adjust an absorption wavelength of the plasmon resonance.

### Embodiment 5

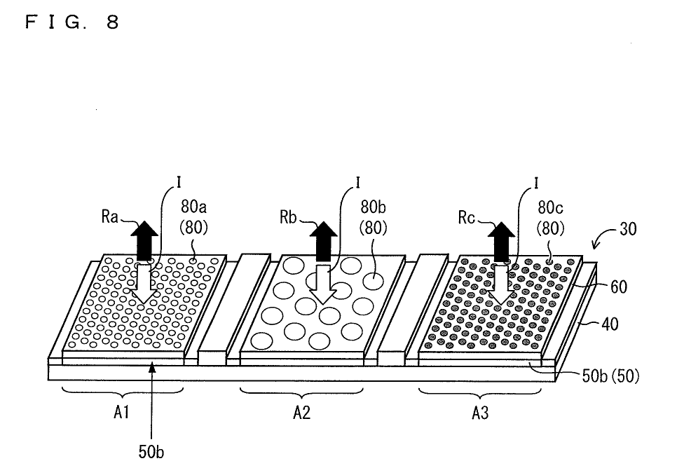

The following describes another embodiment of the reflection type display device 10 of the present invention, with reference to FIG. 8.

For convenience of explanation, members having the same functions as those of the members in the drawings described in Embodiments 1 through 4 are given common reference signs, and descriptions of such members are omitted below.

The reflection type display device 10 of the present embodiment is different from the reflection type display device 10 of Embodiment 1, with regard to the arrangement of the solar cell layer 50. That is, in the case of the reflection type display device 10 of Embodiment 1, the solar cell layer 50 is formed as the silicon solar cell layer 50a which is made from amorphous silicon and has the p/i/n structure.

In the case of the reflection type display device 10 of the present embodiment, in contrast, the solar cell layer 50 is formed as a so-called CIS-based (chalcopyrite-based) solar cell (CIS solar cell layer 50b).

That is, in the case of the reflection type display device 10 of the present embodiment, formed on the band-pass filter 40 which serves as a reflector is a CIS solar cell made from a compound which is made up of Cu, In, Ga, Al, Se, S, etc. and referred to as chalcopyrite-based material.

The CIS solar cell is a thin film layer (CIS solar cell layer 50b) which has a thickness of approximately 30 nm and is made from, e.g., Cu(In, Ga)Se₂, Cu(In, Ga)(Se, S)₂, CuInS₂, or the like. Cu(In, Ga)Se₂ and Cu(In, Ga)(Se, S)₂ can be abbreviated as CIGS and CIGSS, respectively.

Further, an ultrathin oxidized film layer 60 is formed to a thickness of 5 nm, on the CIS solar cell layer 50b.

Further, the metal nanoparticles 80 are deposited on the oxidized film layer 60. A method for depositing the metal nanoparticles 80 is not particularly limited, it is possible to employ, in the deposition, e.g., that method described in Embodiment 2 which utilizes the silica nanoparticles.

The metal nanoparticles 80 employed in the present embodiment are the same as those of Embodiment 1. That is, employed as the red metal nanoparticles 80a in the red display region A1 are the gold particles having a particle diameter of 10 nm; employed as the green metal nanoparticles 80b in the green display region A2 are the gold particles having a particle diameter of 40 nm; and employed as the blue metal nanoparticles 80c in the blue display region A3 are the copper particles having a particle diameter of 10 nm.

In the reflection type display device 10 of the present embodiment, the light which exists as evanescent light in the vicinity of the surfaces of the metal nanoparticles 80 after being absorbed by the metal nanoparticles 80 due to their plasmon resonance is absorbed by the CIS solar cell layer 50b via the ultrathin oxidized film layer 60. This makes it possible to reuse the light in the CIS solar cell as absorbed light.

### Embodiment 6

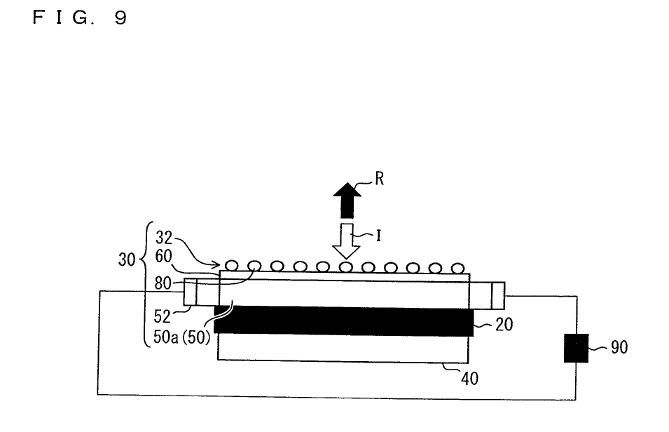

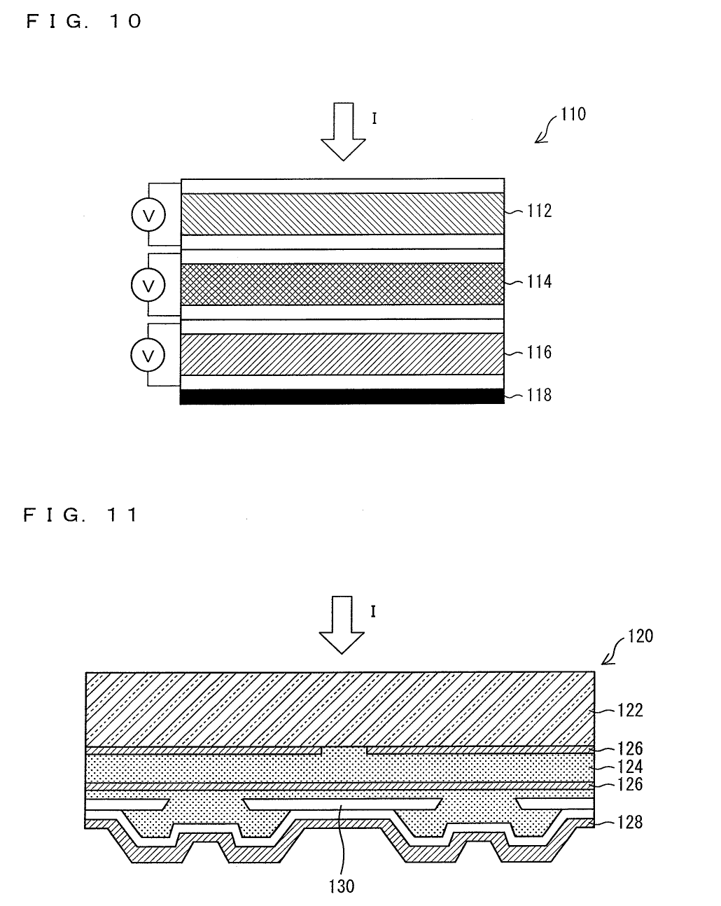

The following describes another embodiment of the reflection type display device 10 of the present invention, with reference to FIG. 9.

For convenience of explanation, members having the same functions as those of the members in the drawings described in Embodiments 1 through 5 are given common reference signs, and descriptions of such members are omitted below.

A reflection type display device 10 of the present embodiment is different from the reflection type display device 10 of Embodiment 1 in position of the light shutter 20. That is, in the case of the reflection type display device 10 of Embodiment 1, the light shutter 20 is provided above the main part 30 (which is made up mainly of the plasmon resonance layer 32 and the solar cell layer 50).

In the reflection type display device 10 of the present embodiment, in contrast, the light shutter 20 is provided below the main part 30 (which is made up mainly of the plasmon resonance layer 32 and the solar cell layer 50).

FIG. 9 is a view illustrating a schematic arrangement of the reflection type display device 10 of the present embodiment. As illustrated in FIG. 9, in the reflection type display device 10 of the present embodiment, the light shutter 20 is provided between a band-pass filter 40 which serves as a reflector and a plasmon resonance layer 32, an oxidized film layer 60, a solar cell layer 50.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

As described above, the reflection type display device of the present invention includes: a metal nanoparticle dispersion layer in which metal nanoparticles are dispersed; a reflector for reflecting transmitted light which has passed through the metal nanoparticle dispersion layer; a light shutter for adjusting an intensity of light reflected by the reflector; and a solar cell layer for storing evanescent wave from the metal nanoparticles.

The arrangement makes it possible to realize a reflection type display device which can reuse unnecessary light in a display system by use of a solar cell. Such a reflection type display device makes it possible to provide an environmentally-friendly reflection type display product. Also, it is possible to provide a reflection type color display device with high reflectance and high definition.

That is, the metal nanoparticles absorb light in a specific wavelength band due to their plasmon resonance which occurs on their surfaces. The metal nanoparticles thus serve as a color filter. Plasmon refers to a quantum as which collective oscillations of free electrons in a metal are regarded. The metal nanoparticles cause surface plasmons which are different in oscillation from those of a bulk metal. Interaction between the surface plasmons and light is referred to as surface plasmon resonance. Among others, in the case of metal nanoparticles of gold, light in a range from the visible light region to a near-infrared region and plasmons are coupled to each other so as to cause light absorption, and similarly, in the case of metal nanoparticles of silver, light in a range from an ultraviolet light region to the visible light region and plasmons are coupled to each other so as to cause light absorption.

As described above, a surface plasmon resonance wavelength varies depending on a particle diameter and a medium. Examples of metals which cause surface plasmon resonance in the visible light region and in the vicinity thereof encompass Au, Ag, Cu and Al. Since an absorption wavelength band varies depending on conditions such as a size (particle diameter) of the metal nanoparticles and a material thereof, expression of the RGB colors or the like is realized by selecting the conditions.

As a result of light absorption due to plasmon resonance, caused in the vicinity of the surfaces of the metal nanoparticles is light which is referred to as evanescent wave and which does not propagate. The evanescent wave leaks down to the solar cell layer. Accordingly, the light absorbed by the metal nanoparticles due to their plasmon resonance is converted into electrons so as to be stored in the storage battery. Then, the electric power is supplied from the storage battery to, e.g., the light shutter element so as to be reused in the driving thereof. As described above, the light shutter element adjusts light intensity by use of liquid crystal or a MEMS element.

On the other hand, light having a wavelength which is not involved in the plasmon resonance is hardly lost due to the absorption by the ultrathin solar cell layer but is reflected by the reflector below so as to be emitted as reflected light.

Thus, the reflection type display device of the present invention has both a color filter function and a solar cell function. Specifically, the reflection type display device has the color filter function of absorbing light having a wavelength which is unnecessary for color display. Further, the reflection type display device reuses the light as electric power by use of a solar cell. This makes it possible to provide a high-definition display device, without impairing its display performance.

Further, the reflection type display device of the present invention is arranged such that a particle diameter of the metal nanoparticles is not smaller than 1 nm but not greater than 200 nm.

Further, the reflection type display device of the present invention is arranged such that at least one of silver, gold, copper, and aluminum is employed as a material for the metal nanoparticles.

According to the arrangement, the particle diameter of the metal nanoparticles is not smaller than 1 nm but not greater than 200 nm. Further, according to the arrangement, at least one of silver, gold, copper, and aluminum is employed as a material for the metal nanoparticles.

According to the arrangement, the metal nanoparticle can efficiently cause plasmon resonance. This makes it easier to develop, e.g., the RGB (Red-Green-Blue) colors and the CMY (Cyan-Magenta-Yellow) colors.

The recitation “ . . . one of silver, gold, copper, and aluminum is employed as a material . . . ” does not always indicate that a single material is employed for the metal nanoparticles. The recitation also indicates that, e.g., an alloy containing the one material is employed as the material for the metal nanoparticles.

Further, the reflection type display device of the present invention is arranged such that: the metal nanoparticles are encased in a dielectric material.

A wavelength of light to be absorbed due to the plasmon resonance is shifted depending on a dielectric constant of a dielectric material in the vicinity of the metal nanoparticles.

According to the arrangement, the metal nanoparticles are encased in the dielectric material, i.e., are covered with the dielectric material. Accordingly, by changing a dielectric constant of the dielectric material, in other words, by changing a refractive index of the dielectric material, it is possible to adjust a color to be developed due to plasmon resonance.

According to the arrangement, further, since the metal nanoparticles are encased in the dielectric material, the metal nanoparticles can be retained surely and protected by the dielectric material.

Further, the reflection type display device of the present invention is arranged such that: the dielectric material is a UV curable resin.

According to the arrangement, the dielectric material is a UV curable resin, and therefore, it is easy to cure the dielectric material.

Accordingly, it is easy to encase and retain the metal nanoparticles therein.

Further, the reflection type display device of the present invention is arranged such that: said metal nanoparticle dispersion layer has a plurality of regions in which the metal nanoparticles are dispersed; the metal nanoparticles differ in type among the plurality of regions; and the plurality of regions contain a region which allows emission of red light, a region which allows emission of green light, and a region which allows emission of blue light.

Further, the reflection type display device of the present invention is arranged such that: a wavelength of light to be absorbed by the metal nanoparticles due to plasmon resonance thereof differs among the plurality of regions so that the plurality of regions emit light of different colors.

Further, the reflection type display device of the present invention is arranged such that: an insulator layer being provided between said metal nanoparticle dispersion layer and said solar cell layer.

In a case where the solar cell layer and the metal nanoparticles have a direct contact with each other, and light enters the solar cell layer so that a photovoltaic power is caused, there is a concern that those free electrons in the metal nanoparticles which cause plasmon resonance are affected by the photovoltaic power so that a plasmon resonance characteristic is changed.

According to the arrangement, the insulator layer is provided between the metal nanoparticle dispersion layer and the solar cell layer. This makes it possible to suppress the change in plasmon resonance characteristic.

Further, the reflection type display device of the present invention is arranged such that amorphous silicon is employed as a material for said solar cell layer.

According to the arrangement, amorphous silicon is employed as the material for the solar cell layer. Since amorphous silicon which is a general-purpose material is employed, the arrangement makes it possible to easily form the solar cell layer.

Further, the reflection type display device of the present invention is arranged such that: a chalcopyrite-based material is employed as a material for said solar cell layer.

There are many types etc. of manufacturing methods for the solar cell made from a chalcopyrite-based material. In addition, the solar cell makes it possible to widely cover a range from a low-cost product to a high-performance product. Furthermore, the solar cell allows an increased area thereof and mass-production. Accordingly, it is easy to form a solar cell layer in accordance with use etc. of the reflection type display device.

Further, the reflection type display of the present invention is arranged such that: microcrystalline silicon is employed as a material for said solar cell layer.

The solar cell made from microcrystalline silicon allows absorption of light in a long wavelength region, and a high mobility of an excited carrier. This makes it possible to improve a characteristic of the solar cell.

Further, the reflection type display device of the present invention is arranged such that: said metal nanoparticle dispersion layer, said solar cell layer, and said reflector are provided in this order.

According to the arrangement, the metal nanoparticle dispersion layer, the solar cell layer, and the reflector are provided in this order.

This allows the solar cell layer to surely absorb an evanescent wave from the metal nanoparticle in the metal nanoparticle dispersion layer, and also allows the reflector to reflect the transmitted light from the metal nanoparticle dispersion layer, so that the transmitted light is used in display.

Further, the reflection type display device of the present invention is arranged such that: said reflector is a band-pass filter.

According to the arrangement, the reflector is the band-pass filter which is a filter for allowing light having a specific wavelength or a specific wavelength band to pass through so as to reflect its light portion on a short-wavelength side and its light portion on a long-wavelength side.

This allows higher-definition display.

Further, the reflection type display device of the present invention is arranged such that: said reflector is made from a metal.

According to the arrangement, the reflector is made from a metal. This makes it possible to increase a reflectance of the reflector.

This makes it possible to increase a light utilization efficiency.

Further, the reflection type display device of the present invention is arranged such that: said light shutter is provided between said metal nanoparticle dispersion layer and a main viewer of the display.

According to the arrangement, in a case where the main viewer is located in an upper direction, the light shutter is provided above the metal nanoparticle dispersion layer.

This makes it possible to prevent a decrease in contrast which is caused in such a manner that Fresnel reflection etc. on an interface of the upper surface of the light shutter brighten black display.

That is, in a case where another layer is provided above the light shutter, Fresnel reflection is caused on interfaces of the another layer so that light reflection occurs in black display. As a result, a contrast decreases.

In a case where the light shutter is positioned directly below the main viewer, in contrast, the Fresnel reflection can be prevented. As a result, the decrease in contrast can be suppressed.

Further, the reflection type display of the present invention is arranged such that: said light shutter is provided between said solar cell layer and said reflector.

According to the arrangement, the light shutter is provided between the solar cell layer and the reflector. This allows the incoming light to enter the metal nanoparticles without passing through the light shutter. This makes it possible to efficiently cause plasmon resonance, and also increase an intensity of the evanescent wave.

This makes it possible to easily achieve a high-definition display and a high light utilization efficiency.

Further, the reflection type display device of the present invention is arranged such that: said light shutter is a liquid crystal shutter element.

According to the arrangement, the light shutter is a liquid crystal shutter element. This makes it possible to easily realize the light shutter.

Further, the reflection type display device of the present invention is arranged such that: said light shutter is realized by a micro electric mechanical element.

According to the arrangement, the light shutter is realized by a micro electric mechanical element. This realizes low-power consumption. Also, a high transmittance is achieved while the light shutter opens. This makes it possible to easily perform a high-density display.

The reflection type display device of the present invention achieves a high light utilization efficiency and high-definition display. Therefore, the reflection type display device is suitably applicable to a use of an environmentally-friendly high-quality display device.

### REFERENCE SIGNS LIST

10 Reflection type display device
20 Light shutter
30 Main part (metal nanoparticle dispersion layer, solar cell layer)
32 Plasmon resonance layer (metal nanoparticle dispersion layer)
40 Band-pass filter (reflector)
50 Solar cell layer
50a Silicon solar cell layer (solar cell layer)
50b CIS solar cell layer (solar cell layer)
60 Oxidized film layer (insulator layer)
70 UV curable resin layer (dielectric layer)
80 Metal nanoparticle
80a Red metal nanoparticle (metal nanoparticle)
80b Green metal nanoparticle (metal nanoparticle)
80b1 First green metal nanoparticle (metal nanoparticle)
80b2 Second green metal nanoparticle (metal nanoparticle)
80c Blue metal nanoparticle (metal nanoparticle)

1. A reflection type display device comprising:
a metal nanoparticle dispersion layer in which metal nanoparticles are dispersed;
a reflector being provided so as to overlap said metal nanoparticle dispersion layer in planar view;
a light shutter being provided so as to overlap said metal nanoparticle dispersion layer in planar view; and
a solar cell layer being provided close to said metal nanoparticle dispersion layer,
the reflection type display device performing display in such a manner that:
the metal nanoparticles allow light having a specific wavelength to pass through;
the light is then reflected by said reflector; and
said light shutter adjusts an intensity of the light thus reflected.

2. The reflection type display device as set forth in claim 1, wherein:
a particle diameter of the metal nanoparticles is not smaller than 1 nm but not greater than 200 nm.

3. The reflection type display device as set forth in claim 1 wherein:
at least one of silver, gold, copper, and aluminum is employed as a material for the metal nanoparticles.

4. The reflection type display device as set forth in claim 1, wherein:
the metal nanoparticles are encased in a dielectric material.

5. The reflection type display device as set forth in claim 1, wherein:
the dielectric material is a UV curable resin.

6. The reflection type display device as set forth in claim 1, wherein:
said metal nanoparticle dispersion layer has a plurality of regions in which the metal nanoparticles are dispersed;
the metal nanoparticles differ in type among the plurality of regions; and
the plurality of regions contain a region which allows emission of red light, a region which allows emission of green light, and a region which allows emission of blue light.

7. The reflection type display device as set forth in claim 6, wherein:
a wavelength of light to be absorbed by the metal nanoparticles due to plasmon resonance thereof differs among the plurality of regions so that the plurality of regions emit light of different colors.

8. The reflection type display device as set forth in claim 1, further comprising:
an insulator layer being provided between said metal nanoparticle dispersion layer and said solar cell layer.

9. The reflection type display device as set forth in claim 1, wherein:
amorphous silicon is employed as a material for said solar cell layer.

10. The reflection type display device as set forth in claim 1, wherein:
a chalcopyrite-based material is employed as a material for said solar cell layer.

11. The reflection type display device as set forth in claim 1, wherein:
microcrystalline silicon is employed as a material for said solar cell layer.

12. The reflection type display device as set forth in claim 1, wherein:
said metal nanoparticle dispersion layer, said solar cell layer, and said reflector are provided in this order.

13. The reflection type display device as set forth in claim 1, wherein:
said reflector is a band-pass filter.

14. The reflection type display device as set forth in claim 1, wherein:
said reflector is made from a metal.

15. The reflection type display device as set forth in claim 1, wherein:
said light shutter is provided between said metal nanoparticle dispersion layer and a main viewer of the display.

16. The reflection type display device as set forth in claim 1, wherein:
said light shutter is provided between said solar cell layer and said reflector.

17. The reflection type display device as set forth in claim 1, wherein:
said light shutter is a liquid crystal shutter element.

18. The reflection type display device as set forth in claim 1, wherein:
said light shutter is realized by a micro electric mechanical element.
